(19) United States
(12) Patent Application Publication
(10) Pub. No.: US 2009/0115161 A1
(43) Pub. Date: May 7, 2009

(54) AUTOMATIC TOWING VEHICLE

(76) Inventor: Kimihito Sato, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 12/265,185

(22) Filed: Nov. 5, 2008

(30) Foreign Application Priority Data
Nov. 7, 2007 (JP) 2007-289299

(51) Int. Cl. B60D 1/00

(52) U.S. Cl. 280/400

(57) ABSTRACT

An automatic towing vehicle includes a self-moving vehicle body for moving along a traveling path, an engaging member, a pressing member and an elevating device for moving up and down the pressing member relative to the vehicle body. The vehicle body is movable under a truck body of the truck. The engaging member is mounted on the vehicle body and engageable with the truck body. The pressing member is mounted on the vehicle body and movable up for pressing the truck body upward. When the pressing member is located under the truck body and moved up by the elevating device, the pressing member is brought to contact with the truck body to press upward. The truck is towed while the pressing member presses against the truck body.

### BACKGROUND OF THE INVENTION

The present invention relates to an unmanned towing vehicle or automatic towing vehicle. More specifically, the present invention relates to a low-floored automatic towing vehicle having a self-moving vehicle body equipped with an engaging member and movable under a truck body for towing the truck by using the engaging member.

Automatic vehicles for towing a wheeled platform or truck are used which are movable along a traveling path while detecting a guide wire such as a magnetic tape laid along the traveling path. Some vehicles are low-floored automatic towing vehicles having a self-moving vehicle body with an engaging member and movable under the truck body for towing operation. Such a low-floored automatic towing vehicle is disclosed by Japanese Utility Model Application Publication No. 56-110058. The towing vehicle of this publication has an electromagnetic plunger, a link mechanism and an engaging pin. When the towing vehicle is moved under a truck body, the engaging pin is raised by the plunger through the link mechanism to be inserted between a pair of holding members provided on the truck body. The automatic towing vehicle moves along the traveling path with the engaging pin engaged with the paired holding members.

Since the low-floored automatic towing vehicle is designed to work under a truck vehicle to be towed thereby, the vehicle is required to be small and low enough to be moved in a space between the truck bottom and the ground. In view of the fact that the towing capability largely depends on the weight of the towing vehicle, however, the vehicle is required to be heavy enough for the towing operation. For this purpose, the weight of the vehicle may be increased by providing additional weight to the vehicle in towing a heavy-duty truck. Such addition of weight makes the vehicle not only heavier, but also larger in size, which will require a high-power motor for driving the towing vehicle. The use of such a high-power motor in towing a truck with light loads means a decreased efficiency of the towing vehicle.

The present invention, which has been made in light of the above problems, is directed to a low-floored automatic towing vehicle capable of towing heavy-duty loads for the small size of the vehicle.

### SUMMARY OF THE INVENTION

The present invention provides an automatic towing vehicle for towing a truck. The towing vehicle includes a self-moving vehicle body for moving along a traveling path, an engaging member, a pressing member and an elevating device for moving up and down the pressing member relative to the vehicle body. The vehicle body is movable under a truck body of the truck. The engaging member is mounted on the vehicle body and engageable with the truck body. The pressing member is mounted on the vehicle body and movable up for pressing the truck body upward. When the pressing member is located under the truck body and moved up by the elevating device, the pressing member is brought to contact with the truck body to press upward. The truck is towed while the pressing member presses against the truck body.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a side view showing an automatic towing vehicle according to a preferred embodiment of the present invention;

FIG. 2 is a schematic view showing an elevating device of the automatic towing vehicle of FIG. 1;

FIG. 3 is a side view showing a state of the elevating device of FIG. 2 wherein its pressing member is elevated; and

FIG. 4 is a side view showing a state of the elevating device of FIG. 2 wherein its pressing member is lowered.

### DETAILED DESCRIPTION OF THE PREFERRED EMBODIMENTS

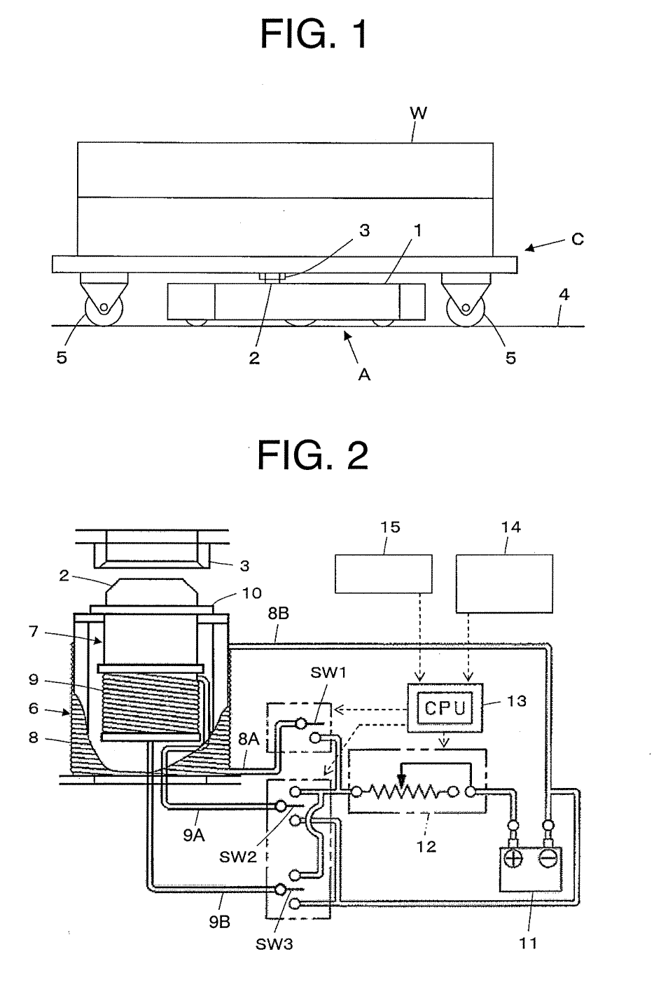

The following will describe an automatic towing vehicle according to a preferred embodiment of the present invention with reference to the accompany drawings. Referring to FIG. 1 showing a low-floored automatic towing vehicle A according to the preferred embodiment, the towing vehicle A is made small enough to move under a body of a wheeled platform or a body of a truck C (truck body). The towing vehicle A has a self-moving vehicle body 1 and an engaging pin 2 located on the top of the vehicle body 1. The truck body has formed in the bottom thereof a holder 3 with which the engaging pin 2 is engageable. The engaging pin 2 serves as an engaging member. The engaging pin 2 is movable up and down relative to the vehicle body 1 by an elevating device the structure of which will be described later. The engaging pin 2 is engaged with the holder 3 thereby to connect the vehicle body 1 to the truck body by moving up to its elevated position and inserted in the holder 3.

The towing vehicle A is operable to move along a traveling path 4 on the ground while detecting a guide wire such as a magnetic tape laid along the traveling path 4 by a detector (not shown) mounted on the vehicle body 1 of the towing vehicle A. The truck C has wheels 5 for facilitating movement and a load W on the top of the truck body.

FIG. 2 shows the elevating device of the automatic towing vehicle A for controllably moving up and down the engaging pin 2 relative to the vehicle body 1. The elevating device has a substantially cylindrical guide member 6 and an elevating member 7. The guide member 6 is fixed to the vehicle body 1 and extends in the axial direction of the engaging pin 2. The guide member 6 has a cylindrical member made of magnetic body such as iron and a coil 8 wound around the outer circumferential surface of the cylindrical member only on a part thereof in the axial direction. The elevating member 7 is received in the guide member 6 and movable up and down along the guide member 6. The elevating member 7 has a rod made of magnetic body such as iron and a coil 9 wound around the outer circumferential surface of the rod on a lower half thereof in the axial direction. The guide member 6 forms an electromagnet which generates magnetic field when an electric current flows in the coil 8. The elevating member 7 also forms an electromagnet which generates magnetic field when an electric current flows in the coil 9.

When electric currents flow through the coils 8, 9 in such directions that create repelling force between the guide member 6 and the elevating member 7, the elevating member 7 is moved upward to its elevated position along the guide member 6. When electric currents flow through the coils 8, 9 in such directions that create attracting force between the guide member 6 and the elevating member 7, the elevating member 7 is moved downward to its lowered position along the guide member 6.

The rod of the elevating member 7 has a diameter smaller than that of the top opening of the guide member 6 and extends therethrough. An annular pressing member 10 is fixed to the rod of the elevating member 7 at the periphery thereof above the top opening of the guide member 6. In the present embodiment, the upper end portion of the rod of the elevating member 7 also serves as the engaging pin 2 engageable with the holder 3 of the truck body. The pressing member 10 has an outer diameter that is larger than that of the top opening of the guide member 6. The lowermost position of the elevating member 7 is determined by contact of the pressing member 10 at the lower surface thereof with the top surface of the guide member 6, as shown in FIG. 2.

The holder 3 of the truck body has an insertion hole into which the engaging pin 2 is insertable. The diameter of the insertion hole of the holder 3 is larger than that of the engaging pin 2 and smaller than the outer diameter of the pressing member 10. The holder 3 and its vicinities are preferably made of non-magnetic material.

The coil 8 of the guide member 6 has two opposite first and second ends 8A, 8B. The first end 8A is connected to a first switch SW1 and the second end 8B is connected to negative electrode of a battery 11. The first switch SW1 is connected to positive electrode of the battery 11 through a variable resistor 12. The coil 9 of the elevating member 7 has two opposite first and second ends 9A, 9B. The first end 9A is connected to a second switch SW2 and the second end 9B is connected to a third switch SW3. The second switch SW2 is selectively connectable to either one of the positive electrode of the battery 11 through the variable resistor 12 and the negative electrode of the battery 11. Similarly, the third switch SW3 is selectively connectable to either one of the positive electrode of the battery 11 through the variable resistor 12 and the negative electrode of the battery 11.

The body 1 of the towing vehicle A has mounted thereon a central processing unit (CPU) 13. The CPU 13 is operable to make, break, or change the connection of the switches SW1, SW2, SW3. In addition, the CPU 13 is operable to change the resistance of the variable resistor 12 thereby to adjust the electric currents flowing through the coil 8 of the guide member 6 and the coil 9 of the elevating member 7. Furthermore, the CPU 13 is operable to detect the slippage of driving wheels of the towing vehicle A based on the detection signals from a supply power detector 14 detecting power supplied to a driving motor (not shown) mounted on the vehicle body 1 of the towing vehicle A and an encoder 15 detecting the rotational speed of the driving wheels of the towing vehicle A. The CPU 13 is operable to adjust the electric currents flowing through the coil 8 of the guide member 6 and the coil 9 of the elevating member 7 by the variable resistor 12 in accordance with the detected slippage.

The guide member 6, the elevating member 7, the battery 11, the CPU 13 and the switches SW1, SW2, SW3 cooperate to form the aforementioned elevating device for moving up and down the engaging pin 2 and the pressing member 10. The CPU 13 and the variable resistor 12 cooperate to form a current controller for adjusting the electric currents flowing through the coil 8 of the guide member 6 and the coil 9 of the elevating member 7. In addition, the supply power detector 14 and the encoder 15 cooperate to form a slip detector for detecting the slippage of the driving wheels of the towing vehicle A.

The up-and-down stroke of the elevating member 7 is set greater than the actual distance that the elevating member 7 moves from the state where the pressing member 10 is in contact with the upper end surface of the guide member 6 to the state where the pressing member 10 is in contact with the lower end surface of the holder 3 of the truck body.

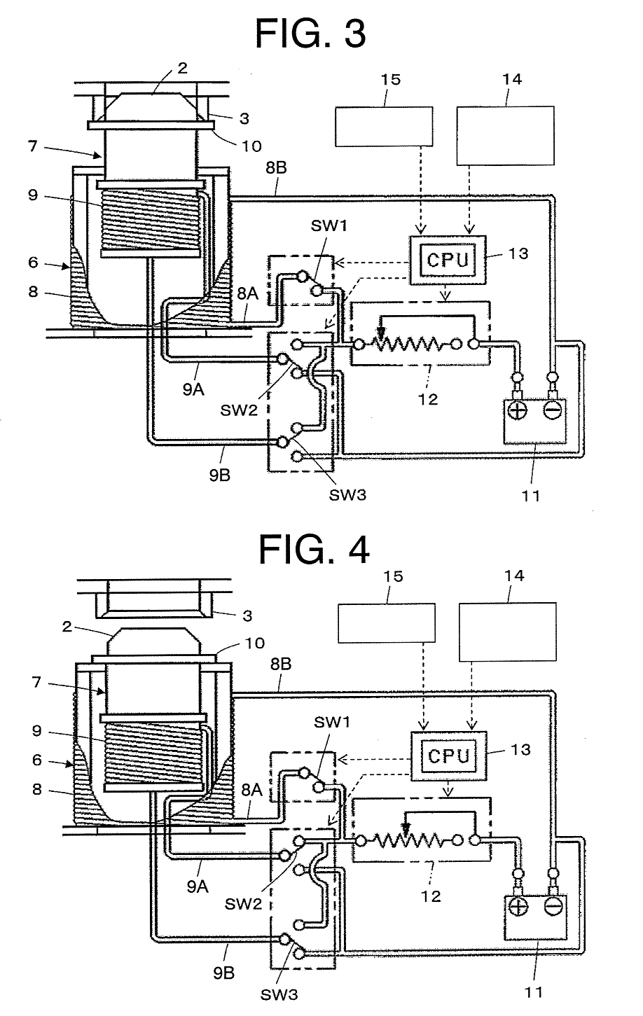

The following will describe the operation of the above-described towing vehicle A. In towing the truck C, the towing vehicle A is moved to a predetermined position under the truck body where the engaging pin 2 is located immediately below the holder 3 of the truck body, as shown in FIG. 1. Subsequently, the CPU 13 is operated to set the switches SW1, SW2, SW3 as shown in FIG. 3. Specifically, the first switch SW1 connects the first end 8A of the coil 8 of the guide member 6 to the positive electrode of the battery 11 through the variable resistor 12. The second switch SW2 connects the first end 9A of the coil 9 of the elevating member 7 to the negative electrode of the battery 11. The third switch SW3 connects the second end 9B of the coil 9 of the elevating member 7 to the positive electrode of the battery 11 through the variable resistor 12.

By so connecting, electric currents flow from the battery 11 to the coil 8 of the guide member 6 and the coil 9 of the elevating member 7 and a magnetic force is generated in the direction that causes the guide member 6 and the elevating member 7 to be repelled from each other. As a result, the elevating member 7 is moved upward along the guide member 6. The engaging pin 2 at the upper end portion of the elevating member 7 is then inserted into the insertion hole of the holder 3, so that the engaging pin 2 is engaged with the holder 3 thereby to connect the vehicle body 1 to the truck body. When the elevating member 7 is moved further upward, the pressing member 10 is brought to contact with the lower end of the holder 3 thereby to press the truck body upward through the holder 3. Pressing the tuck body upward by the pressing member 10, the apparent weight of the truck C is reduced.

Then, the vehicle body 1 is pressed downward through the pressing member 10, the elevating member 7 and the guide member 6 by the reaction force of the pressing force acting to press the truck body upward, so that the apparent weight of the vehicle body 1 is increased. Thus, the apparent weight of the vehicle body 1 is increased without using any weight on the vehicle body 1. Thus, the towing vehicle A is able to tow a heavy truck C despite its small size. Therefore, the towing vehicle A with the pin 2 engaged with the holder 3 of the truck body and the pressing member 10 pressed against the truck body upward carries the truck C along the traveling path 4 to a desired position.

While the truck C is being towed, the CPU 13 monitors power being supplied to the driving motor of the towing vehicle A by using the supply power detector 14 and rotational speed of the diving wheels of the towing vehicle A by the encoder 15. The CPU 13 detects any slippage of the driving wheels of the towing vehicle A by using the supply power detector 14 and the encoder 15.

If any slippage is detected, the CPU 13 considers that the apparent weight of the vehicle body 1 is short and controls the variable resistor 12 so as to increase the electric currents flowing through the coil 8 of the guide member 6 and the coil 9 of the elevating member 7. Because the magnitude of the magnetic force generated in the guide member 6 and the elevating member 7 is increased, the pressing force applied from the pressing member 10 to the truck body upward is also increased. Therefore, the reaction force of the pressing force applied from the pressing member 10 to the truck body upward, that is, the force acting from the truck body downward on the pressing member 10 of the vehicle body 1 is also increased. Thus, the apparent weight of the truck C is further reduced. In addition, the apparent weight of the vehicle body 1 is further increased and, therefore, the towing vehicle A is able to tow the truck C with a heavy load reliably.

The CPU 13 controls the variable resistor 12 to adjust the electric currents flowing through the coil 8 of the guide member 6 and the coil 9 of the elevating member 7 in accordance with the amount of slippage of the driving wheels. By so controlling, the apparent weight of the vehicle body 1 of the towing vehicle A relative to the apparent weight of the truck C is adjusted to an optimum value for nullifying the slippage of the driving wheels.

When the truck C is conveyed to a desired position, the towing vehicle A is stopped and the CPU 13 then controls to change the connection of the switches SW2, SW3 as shown in FIG. 4. Specifically, the second switch SW2 connects the first end 9A of the coil 9 of the elevating member 7 to the positive electrode of the battery 11 through the variable resistor 12. The third switch SW3 connects the second end 9B of the coil 9 of the elevating member 7 to the negative electrode of the battery 11.

By so connecting, the electric current flows through the coil 9 of the elevating member 7 in FIG. 4 in the reverse direction of the electric current for moving up the elevating member 7 in FIG. 3 while the direction of the electric current flowing through the coil 8 of the guide member 6 remains unchanged. Because the magnetic force is created so as to attract the guide member 6 and the elevating member 7, the latter elevating member 7 is moved downward along the guide member 6. Thus, the pressing member 10 is moved away from the holder 3 thereby to release the truck C from the pressing force of the pressing member 10. In addition, because the engaging pin 2 exits from the holder 3, the vehicle body 1 is separated from the truck C. When the elevating member 7 moves down to its lowermost position, as shown in FIG. 2, the CPU 13 shuts off the connection of the switches SW1, SW2, SW3 thereby to stop supplying electric currents to the coils 8 and 9.

For moving the elevating member 7 downward, it is not necessary to pass the electric currents through the coils 8 and 9 as described above for causing the guide member 6 and the elevating member 7 to be attracted to each other. Alternatively, the elevating member 7 may be moved downward by its own weight simply by stopping supplying the electric currents to the coils 8 and 9. It is noted, however, that the elevating member 7 can be moved down rapidly by forcing the elevating member 7 downward by using magnetic force. If the towing vehicle A is stopped due to any failure during the towing operation, the engaging pin 2 can be removed from the holder 3 easily by moving down the elevating member 7 using magnetic force. Thus, remedy for the above failure of the towing vehicle A can be accomplished quickly and easily.

The towing vehicle A in which the elevating member 7 is moved up and down along the guide member 6 by passing the electric currents through the coil 8 of the guide member 6 and the coil 9 of the elevating member 7 is advantageous in that its elevating device is made simple. In addition, the towing vehicle A according to the embodiment of the present invention is capable of towing a truck having a heavy load by reducing the apparent weight of the truck C as described earlier. Making the holder 3 and its vicinities of non-magnetic material, they will not be magnetized by the magnetic force generated in the guide member 6 and the elevating member 7 and, therefore, smooth up-and-down movement of the elevating member 7 is ensured.

In above-described embodiment, the guide member 6 and the elevating member 7 of the elevating device have the coils 8 and 9, respectively. However, the elevating device may be made in such a way that either one of the guide member 6 and the elevating member 7 has an electromagnet and the other has a permanent magnet. In this case, the elevating member 7 is moved up and down relative to the guide member 6 by flowing an electric current through the coil 8 or 9 in such a direction that creates repelling force or attracting force between the guide member 6 and the elevating member 7. Because the truck C is towed while the pressing member 10 of the elevating member 7 presses against the truck C upward, the same effect of the above-described embodiment is obtained.

Alternatively, the elevating device may be made in such a way that either one of the guide member 6 and the elevating member 7 has an electromagnet and the other has a magnetic material. In this case, the elevating member 7 is moved up relative to the guide member 6 by flowing an electric current through the coil 8 or 9 in such a direction that creates attracting force between the guide member 6 and the elevating member 7. The elevating member 7 is moved down by its own weight by stopping supplying the electric current to the coil 8 or 9.

In above-described embodiment, the elevating member 7 is pressed against the truck body in contact with the lower end of the holder 3 of the truck body by way of the annular pressing member 10 fixed to the outer periphery of the rod of the elevating member 7. However, the present invention is not limited to such structure. It may be so arranged that the top surface of the engaging pin 2 is brought to contact with the lower surface of the truck body when the engaging pin 2 is inserted into the insertion hole of the holder 3 of the truck body. In this case, the top surface of the engaging pin 2 serves also as a pressing member movable into pressing contact with the lower surface of the truck body.

In above-described embodiment, the pressing member 10 and the engaging pin 2 are moved up and down together with the elevating member 7. However, the pressing member 10 and the engaging pin 2 may be provided separately so that the pressing member 10 and the engaging pin 2 are moved up and down by separate elevating devices. Any other engaging members engageable with the truck body for connecting the vehicle body 1 to the truck body may be used instead of the engaging pin 2. The pressing member 10 may be moved up and down by any elevating device other than the device using magnetic force.

Therefore, the present examples and embodiments are to be considered as illustrative and not restrictive, and the invention is not to be limited to the details given herein but may be modified within the scope of the appended claims.

What is claimed is:

1. An automatic towing vehicle for towing a truck, comprising:
a self-moving vehicle body for moving along a traveling path, wherein the vehicle body is movable under a truck body of the truck;
an engaging member mounted on the vehicle body and engageable with the truck body;
a pressing member mounted on the vehicle body and movable up for pressing the truck body upward; and
an elevating device for moving up and down the pressing member relative to the vehicle body, wherein when the pressing member is located under the truck body and moved up by the elevating device, the pressing member is brought to contact with the truck body to press upward, wherein the truck is towed while the pressing member presses against the truck body.

2. The automatic towing vehicle according to claim 1, wherein the elevating device includes a guide member and an elevating member, wherein the guide member is fixed to the vehicle body, wherein the elevating member is received by the guide member and movable up and down along the guide member, wherein the pressing member is engaged with the elevating member, wherein at least one of the guide member and the elevating member has an electromagnet, wherein when a magnetic force is generated between the guide member and the elevating member by excitation of the electromagnet, the elevating member is moved up along the guide member and the pressing member is moved up relative to the vehicle body.

3. The automatic towing vehicle according to claim 2, wherein one of the guide member and the elevating member has an electromagnet and the other has a permanent magnet.

4. The automatic towing vehicle according to claim 2, wherein each of the guide member and the elevating member has an electromagnet.

5. The automatic towing vehicle according to claim 2, wherein when an electric current is passed through the electromagnet in a reverse direction of the electric current for moving up the pressing member, the elevating member is moved down along the guide member thereby to move down the pressing member relative to the vehicle body.

6. The automatic towing vehicle according to claim 2, wherein the engaging member is formed integrally at an upper end portion of the elevating member.

7. The automatic towing vehicle according to claim 2, further comprising a slip detector for detecting slippage of a wheel of the towing vehicle body and a current controller for adjusting an electric current flowing through the electromagnet based on detection signal from the slip detector, wherein when the slippage of the wheel is detected by the slip detector during towing the truck by driving the wheel while the pressing member presses against the truck body, the current controller increases the excitation of the electromagnet thereby to increase magnitude of the magnetic force generated between the guide member and the elevating member, which increases pressing force applied from the pressing member to the truck body.

8. The automatic towing vehicle according to claim 7, wherein the current controller adjusts the electric current in accordance with an amount of slippage of the wheel.
